(19) United States
(12) Patent Application Publication
(10) Pub. No.: US 2006/0061007 A1
(43) Pub. Date: Mar. 23, 2006

(54) Method and apparatus for extruding cementitious articles

(76) Inventors: Hong Chen, Bexley North (AU); Richard John Burwood, Maryland (AU); Ian Andrew Maxwell, Five Dock (AU); Nilmini Sureka Goringe, Seven Hills (AU)

Correspondence Address: KNOBBE MARTENS OLSON & BEAR LLP, 2040 MAIN STREET, FOURTEENTH FLOOR, IRVINE, CA, 92614, US

(21) Appl. No.: 11/273,395

(22) Filed: Nov. 14, 2005

Related U.S. Application Data
(62) Division of application No. 10/168,240, filed on Feb. 11, 2003.

(30) Foreign Application Priority Data
Dec. 15, 1999 (AU) PQ4682

(51) Int. Cl. B29C 47/60

(52) U.S. Cl. 264/211.23

(57) ABSTRACT

A method and apparatus (20) for extruding fibre cement. The extruder comprises a casing (30) with a pair of inter-meshing self-wiping screws (40) rotatably mounted therein. The screws continuously mix and or knead the components of the fibre cement provided through various feed means (61, 62) to form a substantially homogeneous paste and force the paste through a die (50) to form a green cementitious extrudate suitable for curing.

### CROSS-REFERENCE TO RELATED APPLICATIONS

This application is a divisional of U.S. application Ser. No. 10/168,240, which is the 35 U.S.C. § 371 filing of Application No. PCT/AU00/01551, filed Dec. 15, 2000, which was published as WO 01/43931 A1 under PCT Article 21(2) in English.

### TECHNICAL FIELD

The present invention relates to methods and apparatus for extruding cementitious articles in particular fibre reinforced cement building products.

### BACKGROUND ART

Fibre reinforced cement boards and other products have been widely used as materials for walls, ceilings, roofs, floors etc., of buildings and for substitutes for wood trim, frames, etc.

There are many methods for forming and shaping such FRC products including Hatschek sheet process, Mazza pipe process, Magnani sheet process, injection moulding, hand lay-up, casting, filter pressing, roll forming, etc.

Extrusion of fibre cement products has been performed on a limited basis but it has a number of difficulties which have reduced its commercial viability. In the extrusion process, the raw materials that constitute the product are mixed together and kneaded to form a solid that can be forced through a die to form the final shape. The material can be subjected to high pressures at the die. In order to form a uniform product, with good surface finish and consistent properties, it is important that the solid that is presented to the die has an even dispersion of all its components and has good flow properties.

Currently in the art, there are several conventional ways in which the cementitious solid is extruded; however, they are all based on batch mixing/kneading processes. For example, cellulose fibre may be prepared by milling to form a mass of loose fibres (see U.S. Pat. No. 5,047,086). This is then combined with the cementitious material, lime, silica, density modifiers, process aids, etc. and dry mixed thoroughly in a suitable mixer. The required amount of water is then introduced and the material is kneaded in a kneading machine until a paste of the desired consistency and uniformity is obtained. This solid is then fed to the extrusion machine which uses one or more screw conveyors to present the material to the die and produce the force required to push the material through the die. The process of preparing and extruding another batch of cementitious material is then repeated.

Similarly, in another example (U.S. Pat. No. 5,891,374), the fibres, whether they be cellulose or synthetic polymers, are mixed together with the water and dispersed. Then the solid components of the formulation are added, the kneading is done with kneading machines, and solid is fed to the extrusion machine when the desired consistency and uniformity are obtained.

The mixing and kneading part of the preparation is sometimes done in multiple stages, where a combination of twin-paddle mixers and screw conveyors are used to work and homogenise the mix. A constant, continuous feed of the mixture is then supplied to the extrusion machine in an effort to convert what is essentially a batch process in the dry mixing stage to a continuous process at the extrusion stage. This batch-type process is obviously quite inefficient. Several mixers and kneaders are used along with devices to ensure constant feed to the extruder.

A true, fully continuous process of fibre cement extrusion is not known in the prior art. There are many reasons why, to date, no continuous high speed extrusion machines have been used, or indeed, suspected as being suitable for extruding fibre cement including the difficulty with controlled feeding of fiberised cellulose, the high temperatures generated by the speeds and torques generated by these machines, the high intensity localised shearing, the highly abrasive nature of the cementitious, siliceous and other such materials common in the building industry, and the high capital cost of these extrusion machines.

To explain, when the fibres used in fibre-cement building materials were predominantly asbestos, the issues with kneading and dispersion are not as acute. Asbestos has better dispersion and water retention properties than, say, cellulose fibres, but when used as reinforcement in cementitious compositions, still required less extensive use of process aids. Further, as is well-known in the art, the use of asbestos fibres is outlawed in many countries and is undesirable even in those countries where its use is legal.

Accordingly, previous efforts in finding reinforcing fibres for extrudable cementitious pastes have concentrated on non-asbestos fibres and, in particular, choosing or treating such non-asbestos fibres so that their dispersion and water retention characteristics make them suitable for use in extrusion moulding with minimal use of process aids. Synthetic fibres have been considered and are commonly used; however, they are expensive and some are unable to be cured at high temperatures such as in an autoclave. Currently, cellulose fibres remain the fibre of choice for reinforcing cement composites for building materials, where they show excellent performance with regard to mechanical strength, toughness, and durability at a low cost. However, cellulose fibres are difficult to disperse and extrude, and often require the use of powerful process aids.

When fibre cement composites are made with cellulose fibre as the reinforcing agent, the fibre is introduced into the matrix in substantially individual form. That is, the fibres must be dispersed from each other with each fibre having as much contact with the matrix as possible to enable the fibres to be most effective. Fibres that are clumped or matted together cause localised variations in product properties and are deleterious to overall performance. Commercially, cellulose fibre is available mainly in the form of lap, which is similar in appearance to thick paper. In order to disperse the fibres, it is common to use a hammernill. As is well known in the art, the process called ‘fiberising’ uses the rapid impact action of a hammermill to separate out the individual fibres from the lap. It is also possible to use a crusher type grinder to the same effect. The resulting product is a loose mass with a very low bulk density with a consistency resembling cotton wool. As this light and fluffy material is difficult to handle and compacts on storage, it is often produced immediately before use. However, the ease of handling can improve when the fibres are very short, the product acting more like a powder, and it is possible for such material to be bagged and transported. The use of fiberised pulp, and the use of hammermills is associated with noise control, dust control, explosion control, and other expensive issues. Furthermore, the form of the fiberised cellulose is not such that can be easily pumped or conveyed, and accurate continuous feeding is extremely difficult. Efforts have been made to overcome this issue by pelletising the cellulose (e.g., Cellulose Filler Factory makes a product called ‘Topcel’), but these pellets are only 75% cellulose and contain a large amount of undesirable contaminants. Moreover, the fibres are extremely short and weak, and not the kind useful for providing good reinforcement.

With regard to the high temperatures generated by the conventional extrusion processes, a problem arises with the process aids used to plasticise the fibre cement. Cementitious formulations generally contain some quantity of process aids to increase the flow properties and enable the kneading and mixing of the paste to disperse the various ingredients. These process aids can also help in the shape retention properties and enhance the surface finish. It is often the case that these process aids significantly increase the cost of the extruded product.

The process aids used most commonly with fibre cement extrusion (e.g., U.S. Pat. No. 5,047,086) are high viscosity cellulose ethers such as methyl cellulose (MC), hydroxypropyl methylcellulose (HPMC), and hydroxyethyl methylcellulose (HEMC). All of these experience a phenomenon known as high temperature gelation. That is, the viscosity of the additive undergoes a sharp increase when the temperature exceeds a specific limiting temperature known as the gel temperature. The gel temperature of these additives vary with the exact chemistry (i.e., degree of substitution, etc.). Even with conventional single screw fibre cement extruders, cooling jackets are sometimes required to counter the temperature rise in the extruder barrel during long periods of fast running to keep the extrudate below the gel temperature of the process aid being used.

Efforts at solving this problem have been primarily directed as developing process aids with higher gel temperatures. The high rotational screw speed used in the continuous extruders, combined with the narrow clearances can cause considerably more temperature rise in the substance being extruded than is encountered in the use of conventional fibre cement extruders. Thus, it was believed that the use of continuous extruders may not be compatible with the commonly used process aids for fibre-cement.

The temperature rise is also of concern with regard to the setting of the cement and the drying out of the final product. Too high a temperature rise may dry out the product, removing water essential for cement hydration. Further, the thermal acceleration of the cement setting reaction may cause complications in controlling the process control (as well as from a maintenance) point of view.

Continuous extruders also cause difficulties with the use of density modifiers. The use of density modifying additives is well known in the art of making fibre cement. These are used to make the product lighter and more attractive from the handling and installation point of view. Examples of common additives for this purpose are expanded clays such as perlite and vermiculite, low density calcium silicates, fly-ash, and bottom ashes. Many of these additives are highly porous and structurally fragile. Though their structure remains intact during the mixing and kneading stages of conventional fibre cement manufacture, high speed continuous extrusion machines are generally built with very small clearances and induce very large amounts of localised shear. This process damages the structure of these density modifying fillers, pulverising them and increasing their density, thus lowering their efficacy as density modifiers.

The problem of high wear caused by the abrasive nature of the components of fibre cement is closely related to the above mentioned high shear. Very small clearances and rapid rotations of the screws give rise to high wear. Though various metal treatments and coatings are available to improve the wear resistance of the extruder, fibre cement paste is, by nature, more abrasive than the materials they are designed for. Given the high cost of the extruder and its replacement components, this is a deterrent to its use in the low margin fibre cement industry.

The present invention seeks to provide a method and apparatus for extruding fibre cement which overcomes at least some of the difficulties of the prior art or provides a commercial alternative thereto.

### DISCLOSURE OF THE INVENTION

In a first aspect, the present invention provides a fibre cement extruder having a casing and at least a pair of intermeshing self-wiping screws rotatably mounted therein, said screws being arranged to continuously mix and/or knead the components of the fibre cement to form a substantially homogeneous paste, and force the paste through a die to form a green cementitious extrudate suitable for curing.

The screws of the extruder are preferably arranged to provide one or more mixing and/or kneading zones along the length thereof. An extrusion zone directly upstream of the die is also preferably provided to compact and force the paste through the die. A vacuum zone may also be included to degas the paste prior to its entry into the die.

In another embodiment, the screws are arranged to provide a consistent flow of cementitious material through the extruder and a predetermined composition of cementitious material at any preselected point along the length of the screws. The extruder also preferably includes one or more feed inlets along the length of the screws to provide respective components for the fibre reinforced cement to the screws. Directly downstream of each inlet, a mixing and/or kneading zone may be provided to mix and/or knead the incoming feed with the paste.

Such an extruder can be included in an extrusion system with a feeder means adapted to continuously feed components for the fibre reinforced cement to the fibre cement extruder, and a die being placed at the outlet end of the extruder.

In another aspect, the present invention provides a method of extruding fibre reinforced cement comprising subjecting the components of a fibre reinforced cement composition to an extruder having at least a pair of intermeshing self-wiping screws to mix and/or knead the components of the fibre cement to form a substantially homogeneous paste and force the paste through a die.

The components of the fibre cement may be provided separately to the extruder or in pre-compounded form. Preferably, the components of the fibre reinforced cement, including fibres, are provided continuously to the extruder at different points along the length of the screws.

The method may be carried out such that the extrudate leaving the extruder is self-supporting. In addition, the extrudate may be partially or completely supported by the use of internal pressure systems. For example, if a hollow section extrudate is being provided, it may be possible to pressurise the interior of the section to support or even expand the extrudate. Further, the residence time of the cementitious composition in the extruder may be adjusted to permit addition of rapid setting agents.

The applicant has surprisingly found that a particular type of extruder used in the polymer industry is suitable for continuous extrusion of fibre reinforced cement. There are many designs of extrusion machine in the polymer industry which can be fed with many different ingredients directly into the feed section of the extruder. A specific type of polymer extruder is the so-called “self wiping twin screw” (SWTS) extruder. This extruder comprises two screws rotatably mounted in a casing including two parallel cylindrical intersecting bores. The screws are in mesh so that the material to be processed is subjected to a powerful field of shear forces. An example of such a SWTS extruder is disclosed in U.S. Pat. No. 3,883,122. This type of machine is particularly efficient because the intermeshing of the screws provides a self-wiping action which minimises the amount of uncontrolled backflow of substance being pumped. This self-wiping action also acts to clean the interior of the casing thereby reducing clean-up time.

It is this SWTS type extruder which the applicant has most surprisingly found to be not only suitable for extrusion of fibre cement but provide significant advantages over conventional production techniques as will be discussed below.

In particular, with a normal SWTS type extruder for polymer fibres, heating and cooling coils are provided within the casing. No such heating and cooling is necessary for extruding fibre reinforced cement.

### BRIEF DESCRIPTION OF DRAWINGS

FIGS. 1 and 2 are diagrammatic views of the conventional extrusion process and the proposed new apparatus and process respectively, and

FIGS. 3 and 4 are plan and side elevational views of a fibre cement extruder according to an embodiment of the present invention.

### BEST MODE FOR CARRYING OUT THE INVENTION

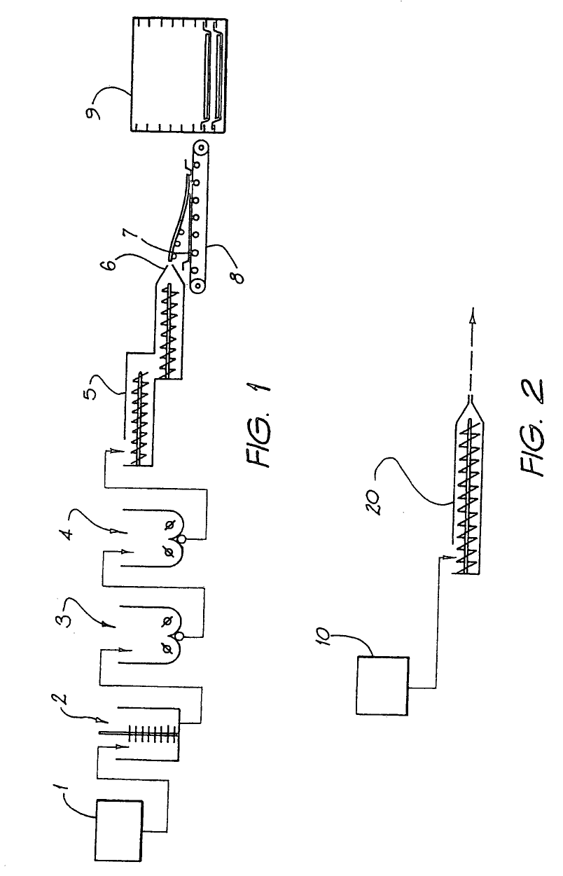

Turning firstly to FIG. 1, a brief explanation of the conventional fibre cement extrusion process will assist in recognising the unique characteristics of the new process and apparatus.

In FIG. 1, the various components of the fibre cement are provided to a weighing plant 1. This weighing plant provides the precise quantities of the various components to a mixer 2, where they are dry and/or wet mixed to the desired homogeneity and consistency. This material is then transferred as a batch to the kneader 30, which kneads the material once again with the optional addition of water. The cementitious solid or paste is then transferred as a batch to a feeder 4. This feeder provides a constant supply of cementitious material to the extruder 5. The entire process up to feeder 4 is a batch-type process.

The extruder 5 forces the cementitious material through die 6. It should be recognised, however, that the extruder simply compacts and forces the cementitious material through a die. No substantive mixing or kneading of the various components occurs in the conventional single screw extruder 5. After exiting the die, the material is supported by trays 7 and transported by conveyor 8 to a stacking area 9.

This conventional technique is clearly limited by the initial batch mixing/kneading process, which is the rate determining step, particularly if it is desired to alter the product formulation.

FIG. 2 is a diagram of the FRC extrusion apparatus in accordance with the present invention. Other than the end operations of product conveying and stacking after leaving the extruder all componentry of the conventional process is replaced by a simple metering plant 10/extruder 20 arrangement. As will be clear to persons skilled in the art in addition to various advantages arising from the extrusion process, the apparatus itself is substantially simpler to use, reduces the footprint of the manufacturing plant and capital cost and is a truly continuous process.

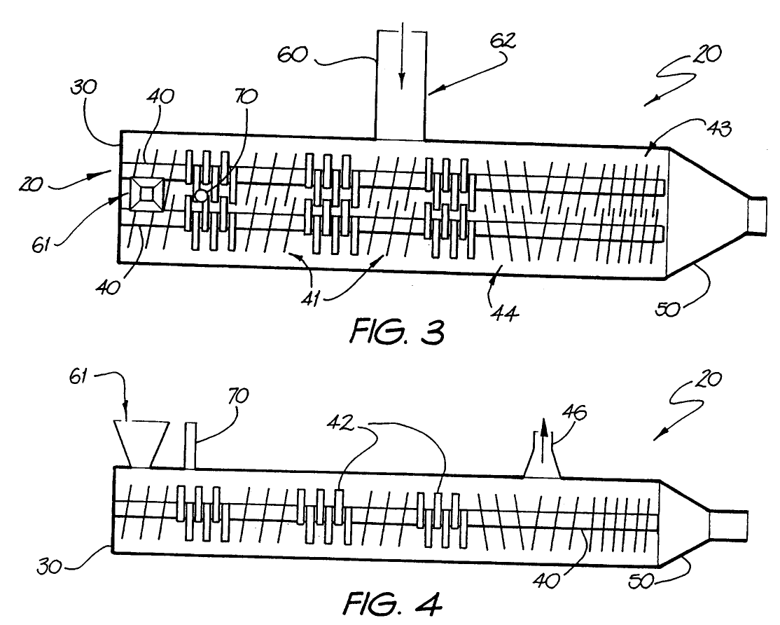

Turning now to FIGS. 3 and 4, the extruder 20 comprises a casing 30 with at least a pair of parallel intermeshing screws 40. In the embodiment shown two screws are shown. It will be appreciated by the person skilled in the art, however, that the extruder could include a greater number of screws and still provide the advantages discussed below.

A die 50 is provided at one end of the extruder from which the extrudate emanates.

Feed means 60 are provided along the length of the casing to feed various components of the fibre cement composition to the screws. A feed hopper 61 is provided at the lead end of the casing. In the embodiment shown, a side feeder 62 is provided approximately half way along the casing. It will be understood from the following description, however, that more than one feed hopper 61 and side feeder 62 may be provided.

One or more apertures 70 may also be provided in the casing for addition of fluids such as water, slurries, and other components such as viscosity enhancing agents, etc. This allows the operator to maintain the desired consistency of the paste passing through the extruder.

Each screw 40 preferably comprises a series of interchangeable components or modules, which define various zones. For example, each screw comprises right-handed screw elements 41, which serve to primarily transport the paste from one zone to the next. Mixing/kneading zones 42 are provided at various points along the length of the screws. In these zones the paste is simultaneously mixed and kneaded to ensure a homogeneous composition. An extrusion zone 43 is provided directly upstream of the die 50 to compact and force the paste through the die. If desired, the screw flights in this area may be more closely spaced together. This is required to provide the desired pressure for compaction and forcing of the paste through the die.

A vacuum zone 44 may optionally be provided upstream of the extrusion zone 43. This zone has a series of left-handed elements, which serve to provide a backflow and build-up of the paste upstream of the vacuum zone. This results in the paste forming a fluid seal between the screw elements and the casing. Downstream, the paste passing through the die similarly forms a fluid seal. The vacuum zone 44, being connected to a vacuum source through outlet 46, thus reduces the pressure in the vacuum zone, and thereby removes any pockets of air or other gases in the paste. As will be appreciated by persons skilled in the art, this degassing of the paste is desirable to ensure no air pockets remain in the paste while it is being forced through the die or in the extrudate leaving the die.

As mentioned above, the screws are made up of a series of interchangeable components or modules. This allows an operator to tailor the speed/residence time of the paste in the extruder, but also the type and quantity of mixing/kneading/shear forces applied to the paste. By providing a consistent flow of the cementitious material through the extruder, an operator can then determine the composition of the cementitious material at any preselected point along the length of the screws.

To explain, in one embodiment, various components may be added at feed hopper 61 with the intention that these components react with each other. It may be necessary to add other components, e.g., low density modifiers, at side feeder 62. It may be preferred that these low density modifiers be added upstream to ensure that the aforementioned components have reacted to the desired degree and to avoid excessive shear force being applied to the low density modifiers. This can be easily obtained with the present invention since the screws 40 can be tailored to provide the necessary residence time and kneading/mixing/shearing between feed hopper 61 and side feeder 62. Alternatively, or in addition thereto, other modules containing side feeders may be moved to the relevant desired point along the length of the screws at which the desired predetermined conditions exist for inclusion of other additives such as pulp.

Accordingly, it can be seen that extruder 20 has virtually an infinite number of variations which allows an operator to tailor the device to produce the required product.

As mentioned above, the extruder also allows the material constituents selected for the final product to be introduced in either individual form or in precompounded form.

A suitable cementitious material is well known in the art and includes cement, lime or lime containing materials such as Portland cement, hydrated lime, or mixtures thereof. Blended cements are also suitable as are combinations of other lime containing materials such as limestone, granulated slag, condensed silica fume.

Suitable fibrous materials can include asbestos; however, it is more preferable to use non-asbestos fibres including cellulose such as softwood and hardwood cellulose fibres, non-wood cellulose fibres, mineral wool, steel fibres, synthetic polymer fibres such as polyamides, polyesters, polypropylene, polymethylpentene, polyacrylonitrile, polyacrylamide, viscose, nylon, PVC, PVA, rayon, and glass, ceramic, or carbon fibres.

The extruder 20 can continuously receive either individual components or components in precompounded form, provide significant advantages over the prior art. There are, of course, a number of ways in which these components may be fed to the extruder.

A preferred method of feeding the fibres, for example, into the above described extrusion machine would consist of the following. Cellulose fibre in lap form is slushed in water with a fibre to water ratio of 4:100. The resulting fibre slurry is then mixed with any component or components of the fibre cement composition that is considered desirable to form a uniform suspension of a solids content of about 10%. A component can be considered desirable if the fibre cement composition is not adversely affected by its prolonged exposure to water, or if for any reason its use in a water dispersed slurry form is advantageous or if it enhances the filterability of the fibre slurry. An example of a desirable component is ground silica, which is often processed in a wet ball mill, and is therefore available in slurry form. It is also non absorptive, and helps with dispersion and the filtration step to be described later. Another example of a desirable component may be any density modifying additives that are to be used in the fibre cement composition. Again, they may be easily obtainable as slurries, but also aid in the overall dispersion and filtration.

The slurry is then de-watered using appropriate de-watering equipment. Such de-watering equipment can be a belt filter press, a centrifuge decanter, a screw press, or the like. The de-watered cake should have a water content no higher than a value which corresponds to the maximum water amount allowable for the extrudable composite mix. The de-watered cake is then broken into small fragments using appropriate equipment, typically a solids mixer. The small cake fragments should be in a size range such that it can be fed into the extruder with a screw feeder.

Another preferred method for feeding the cellulose fibre into the extrusion machine is as follows. The cellulose fibre in lap form is shredded into small pieces using a mechanical device. Such a mechanical device can be a tyre shredder, a granulator, a pin mill, a hammermill, or the like. The shredded lap is still dense enough and flow-able enough to be conveyed continuously by a conveying belt or feeding device such as a screw feeder. The shredded pieces of lap are, however, small enough that they can enter the extrusion machine continuously without blocking the entrance.

Another preferred method for feeding the cellulose fibre into the extrusion machine is as follows. The fibre is obtained or prepared as rolls of lap. The width of the roll is preferably less than the size of the feed entry into the extruder. A system of pinch rollers is arranged such as to convey the ribbon of lap into the feed section of the extrusion machine at a rate determined as desirable by the speed of the production process and the amount of fibre desired in the composite.

Still another method for feeding the cellulose fibre into the extrusion machine may involve a simple water spray adapted to soften the cellulose pulp prior to its entry into the machine. This assists in consistent mixing/kneading of the cellulose into the paste.

In all of the above cases, all other ingredients desired for the fibre cement composition are added as powders or liquids, using appropriate controlled feed machines that are well known in the art.

In the case that the desired fibre cement composition requires the presence of density lowering additives, many density modifiers well known in the art may be used. They can be added dry or as a slurry anywhere along the extrusion machine. If the density modifier is fragile and easily damaged by the degree of shear and compression that they receive in the extrusion machines being described, then their residence times in the machine may be minimised and the screw elements in the machine optimised to minimise the damage.

However, in a preferred embodiment of this invention, the density modifier is composed of hollow glassy spheres. These spheres are commonly formed in the ash from coal burning power stations. They are used as an extender and additive in concrete manufacture, but are not known for use in fibre cement composites. The fly-ash collected in the electrical precipitators or bag-houses of power stations contain glassy spheres whose composition is predominantly alumina and silica. A fraction of these spheres are hollow and can be separated and used as density modifiers. The density of these spheres cover a wide range, and different grades can be used in different amounts to get the desired effect on the density of the product. One example of such spheres are commercially available under the tradename of Extendospheres from PQ Corporation. Spheres of this type are strong enough to withstand the pressure and shear in the extrusion process without substantial damage.

In the practice of this invention, the hollow spheres may be added as a dry free flowing powder, as a pumpable slurry, or in the pre-compounded form with fibre and other ingredients as described earlier. The point at which they are introduced along the screws is also variable according to preference.

In addition to the surprising ability of the SWTS extruder to extrude fibre reinforced cement, many other advantages arose during the development of this invention. These include the ability to extrude pastes stiff enough to stack, the ability to lower the amount or cost of process aids used in extrusion, the ability to use ‘rapid set’ chemistries, the ability to reduce the footprint of the manufacturing plant and the ability to reduce capital cost, the ease of product and formulation changeover, the ease of maintenance, and the ease of using SWTS extruders for product development.

The twin screw extrusion machines that are being proposed here, which combine the compounding actions with the transporting and pressurising actions, have screws intermeshed with very little space between, such that the screws provide a self wiping action on each other are able to extrude fibre cement pastes that are extremely stiff and require high pressures to deform. When such pastes are provided to a traditional fibre cement extruder, the paste would become stuck at the die entrance. The advantage of being able to extrude such stiff pastes is that much lower water contents may be used, enhancing the green strength of the uncured extrudate and the cured strength of the final product. A surface dry extrudate with high green strength and stiffness is a great advantage in processing because uncured products can be stacked on top of each other without any danger of them deforming under the load or becoming adhered to each other.

As discussed above, it was initially anticipated that the temperature rise associated with high-speed continuous extruders would create difficulties when extruding fibre reinforced cement. In fact, the temperature rise encountered in this extruder is also an advantage in this situation because the uncured product has a dry firm surface immediately on exiting the die and is less prone to accidental damage. Furthermore, when fibre cement composites are manufactured using the conventional process and when it is desired that the extruded product have hollow sections, it is often necessary to supplement the cellulose fibre reinforcement with much more expensive, longer fibres such as polymer fibres. Polypropylene fibres are a common example. This is to give the uncured extrudate greater strength to retain shape and support its weight across the hollow sections. The ability to extrude much stiffer products through the SWTS extruder provides a significant cost advantage in minimising the use of expensive longer fibres for hollow sections.

It has been mentioned above that process aids add significantly to the cost of raw materials in fibre cement extrusion. It was discovered that when using the SWTS extruder proposed here, that the levels at which these process aids were needed was significantly reduced. A reduction of viscosifier levels of up to 50% was observed for a typical composition.

In Australian provisional patent application No, PQ 2465, it was demonstrated by the applicant that using a particular combination of certain dispersion agents and viscosity enhancing agents as process aids in extruding fibre cement, a synergistic effect was provided that mitigated the need for high-grade viscosity enhancing agents and enabled the use of alternative or lower grade viscosity enhancing agents that did not undergo thermal gelation. It has been found that such a synergistic combination is also effective in the SWTS extrusion machine to minimise the loss and effectiveness of process aids associated with temperature rise.

For some process aides, such methylcellulose, some cooling of the extruder may be required to reduce the gelling effect. Other process aides such as hydroxyethylcellulose may be used in the extruder without the need for specialist heating or cooling coils.

As mentioned above, the disclosed method and apparatus also allows the use of “rapid set” chemistries. In the fibre cement extrusion process, having a product that cures rapidly on extrusion is advantageous for many reasons. Rapid curing eliminates the need to have the space and special conditions (such as steam rooms and autoclaves) required for prolonged curing. It shortens inventory times and reduces the need for special equipment required to handle uncured product that is not very strong. Though rapid curing chemistries are well known in the cement industry, their use is uncommon in fibre cement extrusion. The reason for this is that the danger is too high of the cement setting too soon and the loss of the large quantities of materials and stoppage to the production process. This is because traditional fibre cement extrusion is a semi continuous process and residence times are hard to control. Also the working volume of the extruder is large, and the nature of the extruders allow considerable back-flow and build up. The self wiping twin screw extruders being proposed here are different in design from conventional fibre cement extruders in that they generally have a smaller working volume and higher rotational frequency in typical operation. This results in an action where small volumes of material are traveling quite rapidly through the process. These machines also have minimal backwards flow of materials and residence times are typically very low and/or can be altered to suit. Furthermore, because of the integrated and continuous nature of the process, additives can be introduced anywhere along the length of the process. Therefore these machines uniquely provide for the use of chemistries that accelerate the set of the fibre cement in a manner that ensures their effectiveness but with a very low risk of the cement setting inside of the machine is very low. Even if these chemistries to be introduced at the earliest part of the machine, the low residence times in the whole machine minimises the risk of cement setting inside the machine, and the higher pressures that this machine is capable of, minimises the prospect of the paste being partially set and thereby too stiff to pass through the die. The heat generated by the extrusion machine (which is greater than the heat generated by a traditional fibre cement extruder) can also be used advantageously to accelerate the setting reaction.

Other advantages of using the self wiping twin screw extrusion technology described here is that it is possible to eliminate several mixers and kneaders required in the traditional fibre cement extrusion process and reduce the overall cost and size of the plant. Since the whole process is integrated and managed by a single control system, it is also possible to reduce the number of personnel required to operate the plant in comparison to a traditional fibre cement extrusion plant.

In the extrusion process, scrap material may be created by accidents in the stacking and handling of uncured extrudate, or for many other reasons. Because the residence times in SWTS machines are so short, and the small working volume and self wiping action of the machine means that materials introduced into the extruder travel as a plug through the extruder without much spread along the screws, scrap materials can be fed back into the extruder either through a side feeder or any of the main feed entrances back into the process, without any risk of destabilising the process. This is a significant cost advantage during manufacture.

Another advantage of using SWTS extruders in a fully continuous process is the ease with which the formulation of the composition being extruded can be changed. Because each component is fed independently and the feed rate can be controlled dynamically while the machine is operating, it is possible to change the proportions and/or the identity of the materials being fed. The very short residence times means the period of transition is also quite short. Because the machine is self wiping, all the material is transported along screw, and there is virtually no old material left in the machine as new material passes through, making it virtually self cleaning. This has several advantages in production. Firstly, if different products are to be manufactured on the same plant, the transition from one product to another can be made seamlessly, without the need to shutdown production, clean the machines, or lose large volumes of materials trapped in the working volume. Secondly, if a shutdown were required, the feeds could be halted and the extruder would virtually empty itself out through the die, leaving very little material in the working volume of the extruder, thus minimising the amount of cleaning required and minimising the risk of cement hardening inside and blocking up the extruder. If it is considered desirable, it is possible to replace the reactive components of the extruding composition with an inert substitute immediately prior to shutdown such that the inert paste replaces the reactive one, and the machine can then be shutdown and left without risk of cement hardening. Thirdly, the ability to vary formulation on the run is a great advantage during product development when several variables can be changed as desired during a very short period of time, and observations of extrudate quality and collection of many different samples can be made with very little time delay.

This invention may be practiced using all or any combination of the different aspects disclosed above. As will be understood by those versed in the art, these choices will be determined by the exact formulation desirable for the finished product and the preferred operating conditions for the specific extrusion machine being used.

It will be appreciated that the disclosed method and apparatus may be embodied in forms other than those disclosed without departing from the spirit or scope of the present invention.

What is claimed is:

1. A method of extruding fibre reinforced cement comprising subjecting the components of a fibre reinforced cement composition to an extruder having at least a pair of intermeshing self-wiping screws to mix and/or knead the components of the fibre cement to form a substantially homogenous paste and force the paste through a die.

2. The method of claim 1, wherein the components of the fibre cement are provided separately to the extruder.

3. The method of claim 1, wherein at least some of the components of the fibre cement are provided to the extruder in a pre-compounded form.

4. The method of claim 1; wherein one or more of the components are provided to the extruder at different points along the length of the screws.

5. The method of claim 1, wherein the extrudate leaving the extruder is self-supporting.

6. The method of claim 1, wherein the constituents of the fibre reinforced cement composition are provided to the extruder in dry form.

7. The method of claim 1, wherein the constituents of the fibre reinforced cement composition are provided to the extruder in liquid or slurry form.

8. The method of claim 1, wherein cellulose fibres are provided to the extruder by a method comprising
i) slushing the fibre in lap form with water,
ii) mixing the resulting fibre with any other component of the fibre cement composition that is not adversely affected by prolonged exposure to water, or with a component which is advantageous to the filterability of the fibre slurry,
iii) dewatering the resulting slurry such that its water content is no higher than the corresponding maximum water content for the extrudable cement mix, and
iv) breaking the dewatered cake into small fragments to be fed into the extruder.

9. The method of claim 1, wherein cellulose fibre is provided to the extruder by mechanically shredding the cellulose fibre in lap form into small pieces and feeding such shredded pieces of lap to the extruder.

10. The method of claim 1, wherein cellulose fibre in the form of a roll or ribbon of lap is fed directly to the extruder at a rate suitable for the speed of production and quantity of fibre desired in the resultant extrudate.

11. The method of any claim 1, wherein prior to entry of the cellulose fibre into the extrusion machine, the fibre is sprayed with water.

12. The method of claim 1, wherein the screws are arranged to provide a mixing portion and/or a kneading portion prior to an extruding portion, the residence times in each portion being adjustable.

13. The method of claim 1, wherein the residence time of the cementitious composition in the extruder can be adjusted to permit addition of rapid setting agents.

14. The method of claim 1, wherein the screws are arranged to provide a consistent flow of cementitious material through the extruder to provide a predetermined composition of the cementitious material at any preselected point along the length of the screws.

15. The method of claim 1, wherein the extruder is run at a temperature sufficient to partially cure or dry the surface of the extrudate leaving the extruder.

16. The method of any claim 1, wherein feed rates of the various constituents and residence times within the extruder can be altered independently to alter the fibre reinforced cement formulation without interrupting production.

17. The method of claim 1, wherein fibres and/or other additives are added as an aqueous suspension with a solids content between 5 and 30%.

18. The method of claim 17, wherein the solids content is between 5 and 15%.

19. A method of extruding fibre reinforced cement comprising subjecting the components of a fibre reinforced cement composition to an extruder, wherein the fibre reinforced cement has a substantially consistent flow and a substantially predetermined composition at any point along the extruder.

20. A method of extruding fibre reinforced cement comprising subjecting the components of a fibre reinforced cement composition to an extruder, wherein the extruded fibre reinforced cement has a substantially predetermined residence time in the extruder.
